(19) United States
(12) Patent Application Publication
(10) Pub. No.: US 2008/0181457 A1
(43) Pub. Date: Jul. 31, 2008

(54) Video based monitoring system and method

(75) Inventors: Rita Chattopadhyay, Bangalore (IN); Archana Kalyansundar, Bangalore (IN)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 12/009,313

(22) Filed: Jan. 17, 2008

(30) Foreign Application Priority Data
Jan. 31, 2007 (IN) 132/KOL/2007

(51) Int. Cl. G06K 9/00

(52) U.S. Cl. 382/103

(57) ABSTRACT

There is described a video based monitoring system and method. The system comprises an image acquisition module, a movement detection module, and a stationary object detection module. The movement detection module is adapted for detecting the presence of a moving object in a region of interest of said captured video image. The stationary object detection module is adapted for detecting the presence of a stationary object in said region of interest and operable when said movement detection module fails to detect a moving object in a region of interest of a current frame of the captured image. The stationary object detection module includes a pixel-by-pixel comparison module adapted to determine the number of pixels in the region of interest in the current frame whose pixel values match with that of corresponding pixels in an immediately preceding frame. The stationary object detection module further includes a background identification module adapted to identify those pixels in the region of interest in the current frame that form part of a background, based upon a comparison of their pixel values with a background pixel value. The system further includes means for generating a signal to indicate detection of a stationary object when the number of matches between the current frame and the immediately preceding frame exceeds a threshold value after discounting those pixels in the current frame that are identified to be part of the background.

### CROSS REFERENCE TO RELATED APPLICATIONS

This application claims priority of Indian Patent Office application No. 132/KOL/2007 IN filed Jan. 31, 2007, which is incorporated by reference herein in its entirety.

### FIELD OF INVENTION

The present invention relates to video based monitoring, particularly for detecting a stationary object in a video based monitoring system.

### BACKGROUND OF INVENTION

Video based monitoring systems such as traffic monitoring systems generally use image processing algorithms based on background subtraction to detect the presence of a vehicle in a region of interest. Typically, background subtraction is used to distinguish moving objects from a background scene by thresholding the difference between an estimate of the image without the moving object and the current image. Background subtraction may be implemented using a number of known techniques.

For example, the article Stauffer C, Grimson W. E. L., “Adaptive background mixture models for real-time tracking”, in Proceedings. 1999 IEEE ComputerSociety Conference on Computer Vision and Pattern Recognition (Cat. No PR00149). IEEE Comput. Soc. Part Vol. 2, 1999, discusses a method of background subtraction by modeling each pixel of an image as a mixture of Gaussians and using an online approximation to update the model. The Gaussian distributions of the adaptive mixture model are then evaluated to determine which are most likely to result from a background process. Each pixel is classified based on whether the Gaussian distribution which represents it most effectively is considered part of the background model.

In background subtraction based image processing, whenever a moving object enters a region of interest (ROI), the background subtraction algorithm is able to detect the moving object correctly and accordingly generates a ‘detect’ pulse. However as soon as the moving object becomes stationary, the above method fails to detect its presence since it becomes part of the background. As a result, the algorithm flags ‘no presence’ of the object although the object still lies in the region of interest.

Most existing algorithms that detect a stationary vehicle are based on speed measurements and hence are computationally intensive and time consuming. These methods are based on motion vectors which are highly complex and inefficient with respect to memory and execution time. Many of these algorithms are also probabilistic and iterative based, and hence they have very high and variable response time. Further, many of the prior algorithms are prone erroneous results in case of environmental changes.

### SUMMARY OF INVENTION

It is an object of the present invention to provide an improved video based monitoring technique to detect stationary objects.

The above object is achieved by a video based monitoring system, comprising:
an image acquisition module for capturing a video image containing a region of interest,
a movement detection module adapted for detecting the presence of a moving object in the region of interest of said captured video image, and
a stationary object detection module adapted for detecting the presence of a stationary object in said region of interest and operable when said movement detection module fails to detect a moving object in a region of interest of a current frame of the captured image, said stationary object detection module further comprising:
   a pixel-by-pixel comparison module adapted for comparing the pixel value of a pixel in the region of interest in said current frame to the pixel value of a corresponding pixel in an immediately preceding frame, to determine the number of pixels in the region of interest of the current frame whose pixel values match with that of corresponding pixels in the immediately preceding frame,
   a background identification module adapted to identify those pixels in the region of interest in the current frame that form part of a background, based upon a comparison of their pixel values with a background pixel value, and
   means for generating a signal to indicate detection of a stationary object when the number of matches between the current frame and the immediately preceding frame exceeds a threshold value after discounting those pixels in the current frame that are identified to be part of the background.

The above object is achieved by video based monitoring method, comprising the steps of:
capturing a video image containing a region of interest,
determining whether a moving object is present in said region of interest of the captured video image based upon a background subtraction method, and
upon not detecting a moving object in the region of interest of a current frame of the captured image based upon said background subtraction method, performing a check to detect the presence of a stationary object in said region of interest, wherein performing said check further comprises the steps of:
   comparing the pixel value of a pixel in the region of interest in said current frame to the pixel value of a corresponding pixel in an immediately preceding frame, to determine the number of pixels in the region of interest of the current frame whose pixel values match with that of corresponding pixels in the immediately preceding frame,
   identifying those pixels in the region of interest in the current frame that form part of a background, based upon a comparison of their pixel values with a background pixel value, and
   generating a signal to indicate detection of a stationary object when the number of matches between the current frame and the immediately preceding frame exceeds a threshold value after discounting those pixels in the current frame that are identified to be part of the background.

An underlying idea of the present invention is to provide a method by which sustained detection of a stationary object is achieved with minimal computation. The proposed method comes into effect as soon as the background subtraction method fails to detect a stationary object due to the inherent nature of the background subtraction algorithm.

In a preferred embodiment, in order to improve response time, said stationary object detection module is called only when the said movement detection module fails to detect a moving object in a region of interest of a current frame of the captured image after detecting a moving object in a region of interest of the immediately preceding frame of the captured image.

In one embodiment of the present invention the background pixel value is calculated by generating an image histogram of said region of interest containing background only and, determining therefrom, a pixel value corresponding to a mode of the histogram. The above feature is advantageous as it requires only a single background pixel value to classify whether a pixel in the current frame is part of the background or of a stationary object.

In a particularly preferred embodiment of the present invention, said movement detection module comprises an adaptive multiple Gaussian based background subtraction algorithm. The above technique of background subtraction is particularly useful for multi-modal background distributions.

In one particular embodiment, said object is a vehicle, and said system is adapted for detecting a stationery vehicle in a traffic monitoring system. Embodiments of the proposed system are advantageous in traffic monitoring as they can be used under various illumination conditions such as sunny, overcast, dark night time, among others, and also with large volumes of traffic on the road.

### BRIEF DESCRIPTION OF THE DRAWINGS

The present invention is further described hereinafter with reference to exemplary embodiments shown in the accompanying drawings, in which:

FIG. 1 is a schematic overview of a video based monitoring system,

FIG. 2 illustrates a histogram to calculate a background pixel value,

FIG. 3 is a flowchart illustrating a method for video based monitoring to detect a stationary object,

FIG. 4 illustrates an exemplary application of the proposed technique to detect a stationary vehicle in a region of interest, and

FIG. 5 shows an exemplary graph illustrating an output of a stationary object detection algorithm.

### DETAILED DESCRIPTION OF INVENTION

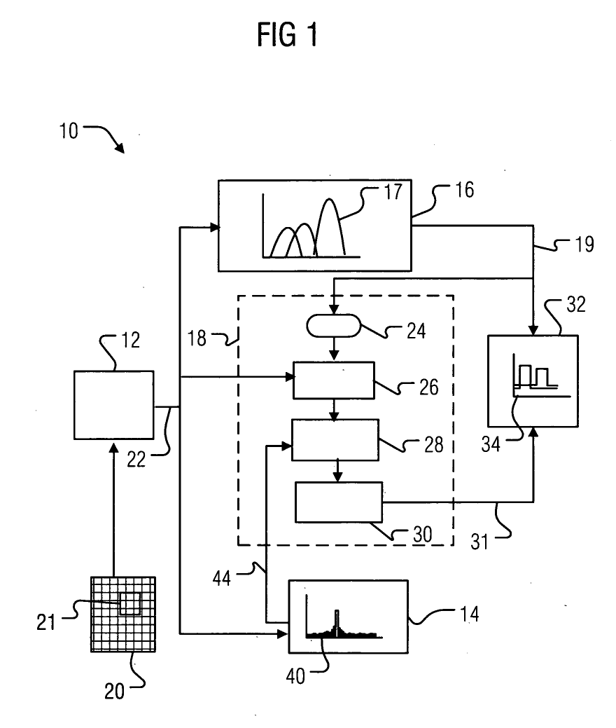

Referring to FIG. 1, a video monitoring system 10 is described in accordance with one embodiment of the present invention. The illustrated system 10 broadly includes an image acquisition module 12, a movement detection module 16 and a stationary vehicle detection module 18.

The image acquisition module 12 captures an input frame 20 of a video image of a scene and generates digital values of individual pixels from the input frame 20. The image acquisition module 12 comprises, for example, a camera having a charged-coupled device (CCD) module to convert a pattern of incident light energy into a discrete analog signal, and an analog-to-digital converter to convert the analog signal into a digital signal 22 representing intensity values for each pixel of the input frame 20. These intensity values are also referred to herein as ‘pixel values’ which describe the brightness and/or color of a particular pixel. For example, in case of grayscale images, the pixel value is a single number that represents the brightness of the pixel.

As used herein, the term ‘region of interest’ or ROI refers to a specific area or region of an image frame for which the proposed method is implemented. The ROI is usually, but not necessarily, lesser than the total area of the image frame. In the illustrated embodiment, the ROI 21 includes only a portion of the total area of input frame 20.

The movement detection module 16 receives the digital signal 22 from the image acquisition module 12 representing pixel values for a sequence of input frames 20 and detects the presence of a moving object in the ROI 21 of the captured video image. The movement detection module 16 typically employs a background subtraction algorithm to distinguish moving objects from a background scene by thresholding the difference between an estimate of the image without the moving object and a current input frame. The illustrated embodiment employs a multiple Gaussian based background subtraction algorithm 17 wherein each pixel of the region of interest 21 of an image frame is modeled as a mixture of Gaussians. The algorithm then determines whether a pixel belongs to a background based upon a comparison of the Gaussian model of said pixel with a background model. The above algorithm is particularly advantageous in case of multi-modal background distributions. However, other techniques for background subtraction may be employed without departing from the scope of the present invention. Such techniques may include, for example, using a single Gaussian pixel model, using kernel density estimation, sequential kernel density estimation, mean-shift estimation, Eigen backgrounds, among others.

The output 19 of the movement detection module 16 is typically a binary pulse including a ‘detected’ or a ‘not detected’ value based upon whether or not a moving object was detected in the region of interest 21 by the background subtraction algorithm 17. This output 19 may also be transmitted to a display module 32, such as a video monitor, that is able to display the output 19 in a graphical format 34.

Whenever a moving body enters the region of interest 21, the movement detection module 16 correctly generates a detect pulse. However as soon as the moving object becomes stationary, the movement detection module 16 fails to detect the presence since it becomes part of the background, and outputs a ‘not detected’ pulse although the object still lies in the region of interest. Whenever the output pulse 19 changes from a ‘detected’ state to a not detected’ state, the stationary vehicle detection module 18 is called into operation to perform a check to detect the presence of a stationary object in the region of interest 21.

The stationary vehicle detection module 18 includes an initiation interface 24 that receives the output 19 of the movement detection module 16 and initiates operation of the proposed stationary object detection algorithm. This output 19 comprises a ‘not detected’ pulse. The functional subsystems of the stationary vehicle detection module include a pixel-by-pixel comparison module 26 that is adapted to carry out a pixel-by-pixel comparison between a current frame and the preceding frame within the region of interest 21. Herein, the pixel value of each pixel in the region of interest in a current frame is compared to the pixel value of a corresponding pixel in an immediately preceding frame for which the background subtraction algorithm had generated a ‘detected’ pulse. If the difference in the compared pixel values falls within a specified limit a (a being a very small number), the corresponding pixel value is considered to have “matched”. The pixel-by-pixel comparison module thus determines the number of such matches between the current frame and the preceding frame in the region of interest 21.

The number of matches determined by the pixel-by-pixel comparison module 26 may be correlated to the presence of a stationary object in the ROI 21, if this number exceeds a threshold area within the ROI 21. However, some of these matches may occur due to the fact that certain pixels in the region of interest of the current frame may be a part of the background. Hence, a background identification module 28 is provided that is adapted to determine the pixels in the ROI of the current frame that are part of the background of the captured scene. To that end, the illustrated embodiment incorporates an on-line background pixel value calculation module 14 to calculate a background pixel value that may be utilized by the background identification module 28 to classify a pixel in the ROI of the current frame as being part of a background or not.

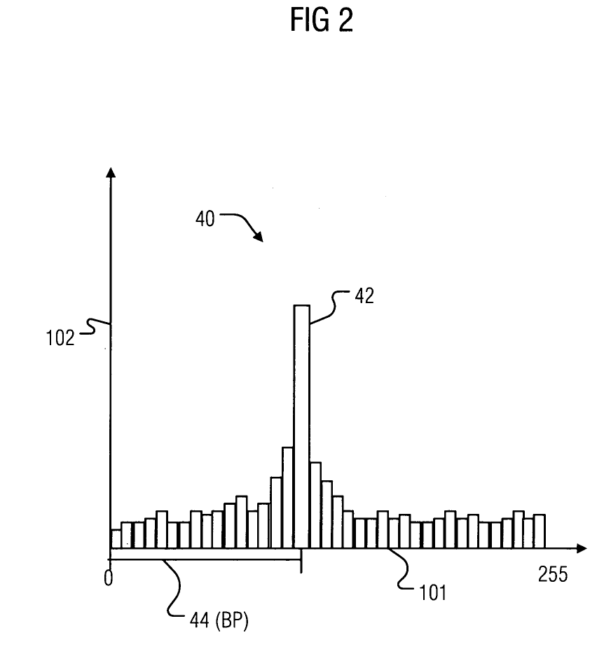

The background pixel value may be calculated by generating an image histogram. A histogram refers to a graph showing the number of pixels in an image frame at each different intensity value (pixel value) found in that image. For an 8-bit grayscale image there are 256 different possible intensities, and so the histogram will graphically display 256 numbers showing the frequency distribution of pixels amongst those grayscale values. FIG. 2 illustrates an exemplary histogram 40 wherein the axis 101 represents pixel intensity or pixel value and the axis 102 represents frequency (number of pixels) of occurrence of said pixel values. The histogram 40 is generated for the ROI in an image frame that contains only background. Since the ROI contains only background, it may be reasonable to assume that the histogram 40 has a single mode 42 representing the most frequently occurring pixel in an ROI containing background only. Once this mode is detected, the corresponding pixel value 44 (BP) is determined which can be considered to be a background pixel value. In case of bi-modal background, the background pixel value 44 (BP) will be located in between the two modes. This single background pixel value (BP) is sent to the background identification module to determine whether a pixel in the current frame belongs to the background or not based on how closely the pixel value matches this background pixel value.

In case of color images, for example in an RGB space, either individual histograms of red, green and blue channels may be generated, or a 3-D histogram can be produced, with the three axes representing the red, blue and green channels, with the intensity at each point representing the pixel count. Hence, a color image would typically include 3 background pixel values representing the modes of 3 separate frequency distributions. In this case, to determine whether a pixel in the current frame belongs to a background, a comparison needs to be made for all 3 background pixel value (i.e. red, blue and green).

The background pixel value is updated online, for example after every 50 frames.

Referring back to FIG. 1, the background identification module 28 is adapted to compare the pixel value of pixels in the ROI of the current frame to the background pixel value 44 (BP) obtained from the background determination module. If the pixel value of a pixel in the current frame is substantially equal to the background pixel value (BP), the pixel is considered to be part of the background and is discounted from calculation. A stationary object is considered to be detected when the number of matches between the current frame and the immediately preceding frame, after discounting those pixels in the current frame which form part of the background, exceeds a threshold value. Under such a condition, a ‘detect’ pulse is flagged by a signal generation means 30 indicating the presence of a stationary object in the ROI. If the above criterion is not satisfied, the signal generation means 30 flags a ‘not detected’ pulse as its output. The selection of the threshold value may depend on the application. For example, in case of a traffic monitoring system to detect the presence of a stationary car in the ROI, the threshold value may be equal to about 35% of the area of the ROI. That is, a ‘detected’ pulse is generated when the number of pixels in the current frame that match those of the preceding frame after discounting the background pixels in the current frame is greater than 35% of the number of pixels in the ROI.

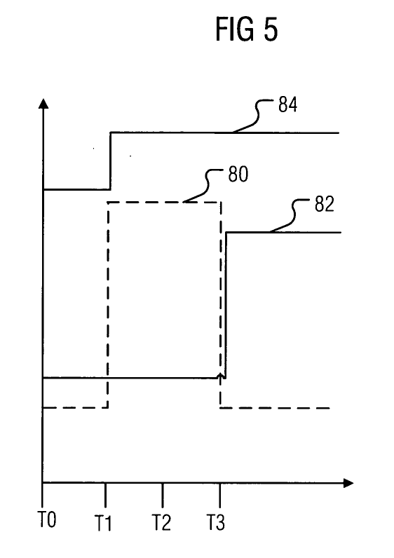

Output 31 of the signal generation means 31 is transmitted to the display module 32, where it may be displayed in a graphical format 34. The graphical nature of the output 19 of the movement detection module 16 and the output 31 of the stationary object detection module 18 are discussed in greater detail with reference to FIG. 5.

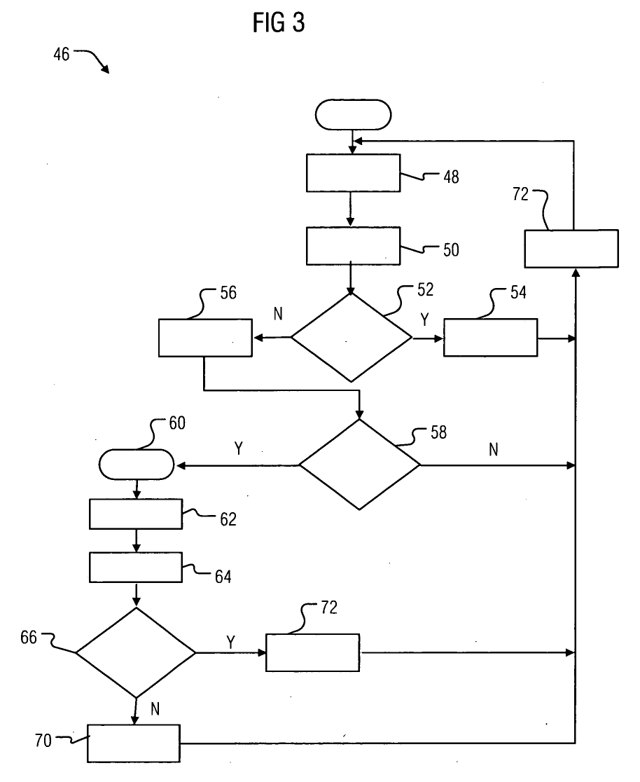

FIG. 3 shows a flowchart illustrating a method 46 for video based monitoring according to one embodiment of the present invention. The method 46 starts at step 48 by capturing a video image of a scene containing a region of interest. Step 50 involves calculation of a background pixel value of the ROI from a captured image of the scene containing background only. As discussed above, step 50 may comprise generating an image histogram of the ROI containing background only. From the histogram, a background pixel value may be calculated by determining the pixel intensity value corresponding to the mode of the histogram, i.e. the pixel value having a maximum frequency of occurrence in the ROI. The background pixel value obtained in step 50 may be updated online. To that end, step 50 may be repeated, for example after an interval of 50 frames.

At step 52, a check is carried out in order to detect the presence of a moving object in the ROI of the captured image. In the illustrated embodiment step 52 includes running a background subtraction algorithm that distinguishes moving objects from a background scene by thresholding the difference between an estimate of the image without the moving object and the current image. When a moving object is detected in step 52, a ‘detected’ pulse is generated (step 54) and displayed (step 72), and control returns to step 48. In the event when no moving object is detected at step 52, a ‘not detected’ pulse is generated (step 56).

As mentioned earlier, in order to improve response time, the stationary object detection module is called when the said movement detection module fails to detect a moving object in a region of interest of a current frame of the captured image after detecting a moving object in a region of interest of the immediately preceding frame of the captured image. Accordingly step 58 of the illustrated embodiment involves performing a check to determine if a ‘detected’ pulse had been generated from the preceding frame, in which case the control moves to step 60, where the proposed stationary object detection algorithm is initiated. At step 62, a pixel-by-pixel comparison is carried out to determine the number of pixels in the ROI of the current frame whose pixel values substantially match with that of corresponding pixels in the immediately preceding frame. Step 64 involves identifying those pixels in the region of interest in the current frame that form part of a background, based upon a comparison their pixel values with the background pixel value obtained in step 50. Next, at step 66, a check is carried out to determine if the number of matches between the current frame and the immediately preceding frame exceeds a threshold value after discounting those pixels in the current frame that are identified to be part of the background. If the above criterion is satisfied, a stationary object is considered to have been detected in the ROI and a ‘detected’ pulse is generated at step 68. If not, a ‘not detected’ pulse is generated at step 70. The output pulse generated after step 66 and that generated after step 52 may be displayed in a graphical format at step 72. The display may further combine the output pulses from step 52 and step 66 using a logical ‘OR’ operation to yield an overall response of the proposed system.

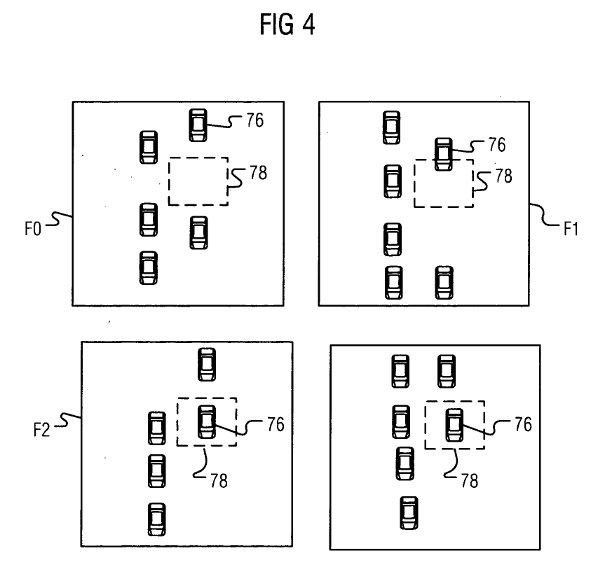

Referring jointly to FIG. 4 and FIG. 5, an exemplary application is illustrated for the proposed technique in a traffic monitoring system to detect a stationary vehicle in an ROI. FIG. 4 depicts the position of a vehicle 76 with respect to an ROI 78 in 4 consecutive frames of a captured video image. The frames have been sequentially labeled F0, F1, F2 and F3. FIG. 5 depicts a graphical representation of the output pulse of the proposed algorithm at times T0, T1, T2 and T3, corresponding to frames F1, F2, F3 and F4 Herein, the pulse 80 (dotted trace) represents an output response of the movement detection module and the pulse 82 (bold trace) represents an output of the stationary object detection module. The overall response of the proposed system is represented by a pulse 84, that combines the responses of the movement detection module and the stationary object detection module using a logical ‘OR’ operation. As can be understood, the maxima of these pulses represent a ‘detected’ state and the minima represent a ‘not detected’ state.

As can be seen, at frame F1, the vehicle 76 is moving, but lies outside the ROI 78. Hence, no object is detected in the ROI, and the algorithm outputs a ‘not detected’ pulse at time T0. At frame F2, the vehicle 76 is still in motion and a part of the vehicle 76 is visible inside the ROI 78. In this case, the movement detection module is able to detect the presence of the moving vehicle, and its output pulse 80 shows ‘detected’ state at time T1. At frame F3, the vehicle 76 continues to be in motion and is fully visible in the ROI 78. The ‘detected’ pulse generated by the movement detection module is hence sustained at time T2. Thereafter, the vehicle 76 stops and retains the same position at frame F4. In this case, the movement detection module fails to detect its presence as the frames F3 and F4 are substantially identical, and therefore outputs a ‘not detected’ pulse at time T3.

The movement detection module thus fails to maintain sustained detection of a stationary car due to inherent nature of the underlying background subtraction algorithm. However, in accordance with the shown embodiment of the present invention, once the output pulse 80 of the movement detection module reaches a ‘not detected’ state, the stationary object detection module is called into operation, which is able to detect the presence of the stationary vehicle 76 at frame F3 hence, its output pulse 82 shows a ‘detected’ state at time T3, even though the pulse 80 still represents a ‘not detected’ state. The output 82 of the proposed stationary object detection module remains in a sustained ‘detected’ state for as long as the vehicle 76 is stationary inside the ROI 78. The overall response 84 thus maintains a sustained ‘detected’ state from time T1 through T3, even thought the vehicle had remained stationary from time T2 onwards. The proposed algorithm operates at a frame interval of 33 milliseconds. The response time is accordingly very low. A smaller frame interval also makes the algorithm robust to environmental changes.

The aforementioned embodiments are advantageous in a number of ways. The technique described provides a sustained detection of an immobile object with minimal computation since all the computations are confined to a given region of interest. Hence, the execution time and the memory requirements for the proposed method are lesser than those of existing methods. The algorithm is thus optimum with respect to time and space. Moreover, since the algorithm uses information from two consecutive frames, which are apart in time by only a few milliseconds, environmental changes do not affect its performance as the environmental changes happen over multiple frames. For the same reason, the response time in the proposed algorithm may be as low as 33 milliseconds in the illustrated embodiments. Further, the proposed algorithm is not iterative based. Hence the response time can be predicted to a very high degree of accuracy. The proposed algorithm is also invariant to camera set ups.

The present invention is particularly advantageous in video based traffic monitoring as it can be used under various illumination conditions such as sunny, overcast, dark night time, among others, and also with large volumes of traffic on the road. The general idea and technique of this invention can be extended to vision based security, surveillance, monitoring, automotives etc. apart from its direct application in traffic monitoring.

Summarizing, the proposed system comprises an image acquisition module, a movement detection module, and a stationary object detection module. The movement detection module is adapted for detecting the presence of a moving object in a region of interest of said captured video image. The stationary object detection module is adapted for detecting the presence of a stationary object in said region of interest (21) and operable when said movement detection module (16) fails to detect a moving object in a region of interest of a current frame of the captured image. The stationary object detection module includes a pixel-by-pixel comparison module adapted to determine the number of pixels in the ROI of the current frame whose pixel values match with that of corresponding pixels in an immediately preceding frame. The stationary object detection module further includes a background identification module adapted to identify those pixels in the region of interest in the current frame that form part of a background, based upon a comparison of their pixel values with a background pixel value. The system further includes means for generating a signal to indicate detection of a stationary object when the number of matches between the current frame and the immediately preceding frame exceeds a threshold value after discounting those pixels in the current frame that are identified to be part of the background.

Although the invention has been described with reference to specific embodiments, this description is not meant to be construed in a limiting sense. Various modifications of the disclosed embodiments, as well as alternate embodiments of the invention, will become apparent to persons skilled in the art upon reference to the description of the invention. It is therefore contemplated that such modifications can be made without departing from the spirit or scope of the present invention as defined.

1-10. (canceled)

11. A video based monitoring system, comprising:
an image acquisition module for capturing a video image containing a region of interest;
a movement detection module for detecting the presence of a moving object in the region of interest of the captured video image; and
a stationary object detection module for detecting the presence of a stationary object in the region of interest and operable when said movement detection module fails to detect a moving object in a region of interest of a current frame of the captured image, wherein the stationary object detection module has:
a pixel-by-pixel comparison module for comparing the pixel value of a pixel in the region of interest in the current frame to the pixel value of a corresponding pixel in an preceding frame, to determine the number of pixels in the region of interest of the current frame whose pixel values match with that of corresponding pixels in the preceding frame,
a background identification module to identify those pixels in the region of interest in the current frame that form part of a background, based upon a comparison of their pixel values with a background pixel value, and
a signal generator for generating a signal to indicate detection of a stationary object when the number of matches between the current frame and the preceding frame exceeds a threshold value after discounting those pixels in the current frame that are identified to be part of the background.

12. The system according to claim 11, wherein the current frame follows immediately the preceding frame.

13. The system according to claim 11, wherein the stationary object detection module is operable when the movement detection module fails to detect a moving object in the region of interest of the current frame of the captured image after detecting a moving object in the region of interest of the immediately preceding frame of the captured image.

14. The system according to claim 11, wherein said background pixel value is calculated by generating an image histogram of said region of interest containing background only and, determining therefrom, a pixel value corresponding to a mode of the histogram.

15. The system according to claim 11, wherein said movement detection module comprises an adaptive multiple Gaussian based background subtraction algorithm.

16. The system according to claim 13, wherein said movement detection module comprises an adaptive multiple Gaussian based background subtraction algorithm.

17. The system according to claim 14, wherein said movement detection module comprises an adaptive multiple Gaussian based background subtraction algorithm.

18. The system according to claim 11, wherein said object is a vehicle, and said system is adapted for detecting a stationery vehicle in a traffic monitoring system.

19. The system according to claim 14, wherein said object is a vehicle, and said system is adapted for detecting a stationery vehicle in a traffic monitoring system.

20. The system according to claim 17, wherein said object is a vehicle, and said system is adapted for detecting a stationery vehicle in a traffic monitoring system.

21. A video based monitoring method, comprising:
capturing a video image containing a region of interest,
determining whether a moving object is present in said region of interest of the captured video image based upon a background subtraction method; and
upon not detecting a moving object in the region of interest of a current frame of the captured image based upon said background subtraction method, performing a check to detect the presence of a stationary object in said region of interest, wherein performing said check further comprises the steps of:
comparing the pixel value of a pixel in the region of interest in said current frame to the pixel value of a corresponding pixel in an immediately preceding frame, to determine the number of pixels in the region of interest of the current frame whose pixel values match with that of corresponding pixels in the immediately preceding frame,
identifying those pixels in the region of interest in the current frame that form part of a background, based upon a comparison of their pixel values with a background pixel value, and
generating a signal to indicate detection of a stationary object when the number of matches between the current frame and the immediately preceding frame exceeds a threshold value after discounting those pixels in the current frame that are identified to be part of the background.

22. The method according to claim 21, wherein said check to detect the presence of a stationary object in said region of interest is performed when no moving object is detected in the region of interest of a current frame of the captured image after detecting a moving object in a region of interest of the immediately preceding frame of the captured image based upon said background subtraction method.

23. The method according to claim 21, further comprising calculating said background pixel value by generating an image histogram of said region of interest containing background only and, determining therefrom, a pixel value corresponding to a mode of the histogram.

24. The method according to claim 22, further comprising calculating said background pixel value by generating an image histogram of said region of interest containing background only and, determining therefrom, a pixel value corresponding to a mode of the histogram.

25. The method according to claim 21, wherein said background subtraction method comprises an adaptive multiple Gaussian based algorithm.

26. The method according to claim 22, wherein said background subtraction method comprises an adaptive multiple Gaussian based algorithm.

27. The method according to claim 23, wherein said background subtraction method comprises an adaptive multiple Gaussian based algorithm.

28. The method according to claim 24, wherein said background subtraction method comprises an adaptive multiple Gaussian based algorithm.
